(19) United States
(12) Patent Application Publication
(10) Pub. No.: US 2006/0155547 A1
(43) Pub. Date: Jul. 13, 2006

(54) Voice activated lighting of control interfaces

(76) Inventors: Alan L. Browne, Grosse Pointe, MI (US); Douglas P. Rheaume, Chesterfield, MI (US); Lawrence E. Peruski, Canton, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/313,217

(22) Filed: Dec. 20, 2005

Related U.S. Application Data
(60) Provisional application No. 60/642,450, filed on Jan. 7, 2005.

(51) Int. Cl. G10L 21/00

(52) U.S. Cl. 704/275

(57) ABSTRACT

A voice activated control interface system for selectively lighting and/or highlighting a control interface for a function generally includes a microphone for receiving a voice command; at least one control interface in operative communication with a function; and a controller in operative communication with the at least one microphone and the at least one control interface, wherein the controller is adapted to process a voice command to provide a signal to a specific one of the at least one control interface to light and/or highlight the at least one control interface. Methods for operating the voice activated control system are also disclosed.

### CROSS REFERENCE TO RELATED APPLICATION

This application claims the benefit of U.S. Provisional Patent Application No. 60/642,450 filed Jan. 7, 2005.

### BACKGROUN

The present disclosure generally relates to control interface systems and processes, wherein a specific control interface is selectively lighted and/or highlighted in response to an input signal from a verbal command.

Numerous motor vehicles employ individual vehicle control interfaces to operate specific functions in and/or out of a vehicle. For example, individual control interfaces can be used to activate, among others, windshield wipers; defrosters; defoggers; heaters for seats; compact disc players; door releases for fuel inlet, the trunk, or hood; interior heating ventilation and air control systems; and the like. Very often these controls are located within the interior of the car in close proximity to the vehicle operator and/or passengers.

Current individual vehicle controls are limited in that the process of locating and operating the various control interfaces may be difficult for those who may not be familiar with the vehicle. These control interfaces are generally in the form of a switch, a button, a handle or a knob that is rotated, pushed, and/or pulled. As used herein, the term “control interface” is intended to include all of the various forms that are utilized to actuate a vehicle function. The vehicle operator must first determine which individual control interface is used for a particular function, which can require a certain amount of time before the operator is familiar with the location. This delay can be problematic such as, for example, when weather conditions drastically change the vehicle operator may need to quickly locate the control interface to operate the specific vehicle function. Moreover, it should be noted that similarly functioning control interfaces are not universally located and may vary depending on the make and model of vehicle.

Another limitation of current vehicle control interfaces is that the process of locating and operating the control interfaces may be difficult during periods of inadequate lighting, e.g., evening hours. Even upon activation of interior light sources or the backlighting of the various control interfaces for the vehicle functions (i.e., lighting that occurs upon activation of the parking lights or headlights), the particular location of the desired control interface may be difficult to find especially when the operator is not familiar with the vehicle, such as may be the case for new car owners as well as for rental car operators. Although some of these control interfaces may have backlighting that assists in identification during less than ideal lighting conditions as noted above, none of these control interfaces are believed to have on-demand lighting and/or highlighting. As such, the process of actuating an individual control interface may be more difficult under conditions of limited visibility or increased stress since the control interface must first be located and the operation thereof must be carried out using only the sense of feel.

Accordingly, there remains a need in the art for improved motor vehicle control interface systems and processes that provide a means for rapid identification.

### BRIEF SUMMARY

Disclosed herein is a voice activated control interface system for selectively lighting and/or highlighting specific control interfaces, a method thereof, and a computer program product for providing voice activated commands. In one embodiment, the voice activated control interface system for selectively lighting and/or highlighting an individual control interface for a function comprises a microphone for receiving a voice command; at least one individual control interface in operative communication with a function; and a controller in operative communication with the at least one microphone and the at least one individual control interface, wherein the controller is adapted to process a voice command to provide a signal to a specific one of the at least one individual control interface to light and/or highlight the at least one individual control interface.

In another embodiment, the voice activated control interface system for selectively lighting and/or highlighting a control interface for a function comprises a microphone for receiving at least one voice activated command; at least one video display unit displaying at least one individual control interface in operative communication with a vehicle function; and a controller in operative communication with the at least one microphone and the at least one individual control interface, wherein the controller processes a voice command to provide a signal to the at least one individual control interface to light and/or highlight the at least one individual control interface.

In yet another embodiment, the voice activated control interface system for selectively lighting and/or highlighting an individual control interface for a function comprises a microphone for receiving at least one voice activated command; a multifunctional haptic control comprising a plurality of individual control interfaces in operative communication with selective functions; and a controller in operative communication with the at least one microphone and the multifunctional haptic control, wherein the controller processes a voice command to provide a signal to the multifunctional haptic control to light and/or highlight a specific one of the plurality of individual control interfaces.

A method for selectively lighting and/or highlighting a control interface for a particular function comprises processing a voice command with a controller to provide a signal to a specific control interface; and lighting and/or highlighting the specific control interface in response to the signal.

The above described and other features are exemplified by the following figures and detailed description.

### BRIEF DESCRIPTION OF THE DRAWINGS

Referring now to the figures, which are exemplary embodiments and wherein like elements are numbered alike:

FIG. 1 is a block diagram of a voice activated control interface system for selectively lighting and/or highlighting the control interface for actuating a particular vehicle function; and

FIG. 2 is a block diagram of a voice activated control interface system in accordance with another embodiment; and

FIG. 3 is a block diagram of a voice activated control interface system in accordance with yet another embodiment.

### DETAILED DESCRIPTION

The present disclosure generally relates to a voice activated vehicle control interface system that selectively lights and/or highlights a particular control interface for a vehicle function in response to an activation signal generated with the voice command. As used herein, the terms ‘lighting and/or highlighting’ is intended to include lighting, highlighting, dimming through intensity, changing light colors, pulsing, or changing the shape characteristics of the light associated with a particular control interface.

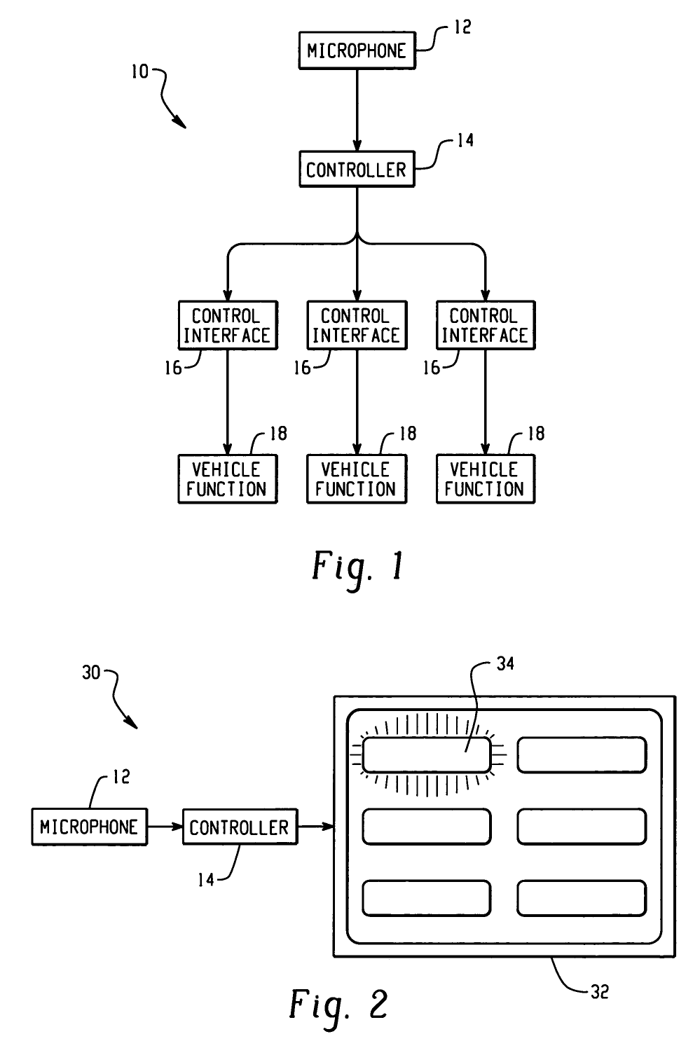

Referring now to FIG. 1, there is shown a block diagram of a voice activated vehicle control interface system generally designated by reference numeral 10. The system 10 generally includes a microphone 12, a controller 14, and one or more individual control interfaces 16 for actuating a specific vehicle function 18. The microphone 12 generally receives a voice command from an operator that is then processed by the controller 14 in operative communication therewith to provide an activation signal specific to an individual control interface 16 based on the particular voice command. The individual control interface 16 is programmed to light and/or highlight in response to the activation signal. In this manner, an operator can rapidly identify an individual control interface 16 for a desired vehicle function 18. The term “microphone” is intended to refer to any speech input or speech recognition technology.

Upon lighting and/or highlighting the control interface, the light intensity for the particular control interface may be programmed to increase, periodically flash, change colors, or the like. In this manner, the operator is advantageously provided with a means for rapidly identifying and locating the control interface 16 under a variety of lighting conditions. For example, in poor lighting conditions, the controller may be programmed to highlight the control interface 16 in the event that the control interface is already lit. Some vehicles have backlighting of the various control interfaces and instrument panels during low light situations, or upon actuation of the exterior parking lights or headlights. Alternatively, the control interface 16 may be programmed to periodically flash in the event the operator is overwhelmed with light, e.g., an operator driving in the direction of the sun at sunset or sunrise. Lighting and/or highlighting the needed control interface provide a means for distinguishing the needed control interface from other control interfaces as well as providing a means for rapid identification thereof and increasing the ease as well as reducing the distraction of establishing physical contact therewith.

The voice activated control interface system 10 utilizes speech recognition technology for lighting and/or highlighting a specific control interface. Suitable voice commands include, but are not limited to, standard words and/or phrases, custom words and/or phrases, and the like. For example, these command words and phrases may relate to a desired vehicle device (e.g., windshield wipers), the desired function (e.g. wipe windshield), a condition for which an operator desires to address with a vehicle function (the event precipitating the need, e.g., rain), or the like. The particular commands for lighting and/or highlighting the specific control interface are unlimited and can be programmed into the controller using speech recognition software. The speech recognition software and associated programming for the controller 14 are well within the skill of those in the art.

In operation, the controller 14 may receive a voice activated command via the microphone 12 for a specific desired function (e.g., “clean windshield”). Based on a specific voice command, a look up table may be accessed and the signal generated by the voice command evaluated thereby such that an activation signal is provided to light and/or highlight one or more control interfaces specific to the voice command (e.g., front windshield wiper control stalk, the rear windshield wiper button, the headlight washer button, and/or the like). The controller 14 is programmed such that upon receiving the specific voice command, the control interface 16 for the desired vehicle function is lit and/or highlighted. The lookup table can be customized based on an individual's preferences and/or the vehicle model, type, or the like. For example, the word “wipe” may be programmed to light and/or highlight all devices related to the windshield wipers, e.g., speed, intermittency, fluid spray. A more specific phrase could then be used to narrow the devices that are and/or highlighted, e.g., the phrase “wipe fluid” could be used to light and/or highlight the interface controlling actuation of windshield washer fluid.

The controller 14 for receiving the input defining signals from the microphone 12 may be a stand-alone unit or programmed as part of an existing controller for a vehicle. For example, the controller 14 may comprise a microprocessor with software, a microcontroller with software, an electronic circuit, a processor with algorithms, a microcontroller with oscillator, or the like. The controller 14 processes the voice command from the microphone 12 and provides the activation signal to light and/or highlight the particular control interface. As such, the controller 14 can be programmed to define, arrange, and prioritize the various voice commands to light and/or highlight various control interfaces. The vehicle owner, operator, and/or manufacturer may preset the desired voice activated command input defining conditions. Optionally, the controller 14 may be programmed to include a timer function. The timer function can be employed to light and/or highlight the particular switch for a predetermined period of time depending on the type of command given. Once the predetermined time is exceeded, the lighting and/or highlighting of the control interface is disabled and/or reset.

The present disclosure may be embodied in the form of computer-implemented processes and apparatuses for practicing those processes. Exemplary embodiments may also be in the form of computer program code containing instructions embodied in tangible media (e.g., floppy diskettes, CD-ROMs, hard drives, or any other computer-readable storage medium) and transmitted over some transmission medium (e.g., via electrical wiring or cabling, fiber optics, or electromagnetic radiation), wherein, when the computer program code is loaded into and executed by a computer, the computer becomes an apparatus for practicing the disclosure.

By way of example, in the event of rain, the operator can provide a voice command that will light and/or highlight the control interface for the windshield wipers. The specific voice commands employed to provide this function are virtually limitless, and can be programmed into and processed by the controller 14 for selectively lighting and/or highlighting the control interface for the windshield wipers. For example, the controller may be programmed to light and/or highlight the windshield wiper control interface upon the voice command, “windshield wipers”. In this manner, the operator can readily identify the windshield wiper control interface by the voice command.

In another embodiment as shown in FIG. 2, a voice activated control interface system 30 can be adapted for use with a vehicle informational display and control interface system, e.g., an operator interactive video display system. A voice command is received by the microphone 12 and processed by the controller 14 to selectively light and/or highlight a specific control interface 34 displayed on a monitor 32. Optionally, the controller 14 can be programmed to provide a video display, informational text, or an animated graphic as a means to light and/or highlight the desired control interface or desired vehicle function.

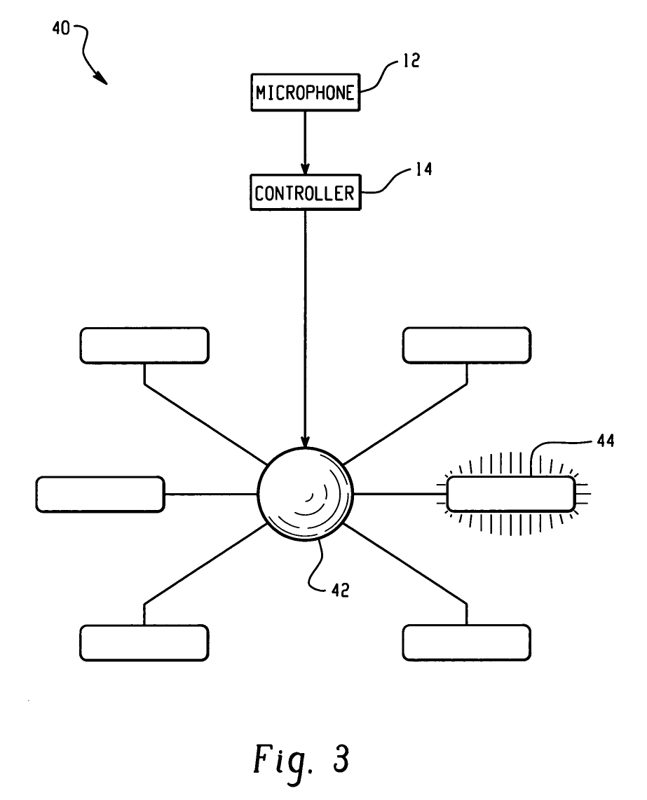

In yet another embodiment as shown in FIG. 3, a voice activated control interface system 40 can be adapted for use with a haptic control 42. The haptic control 42 may comprise a knob that provides selection of control interfaces 44 for different vehicle functionalities. The controller 14 can be programmed for automatically switching the haptic control 42 to the control interface or for lighting and/or highlighting the haptic control when it has been physically switched by the operator to a desired function.

Once the control interface is lit and/or highlighted, the controller can be further programmed to deactivate the lighting and/or highlighting. Suitable approaches include programming the controller to deactivate the lighting and/or highlighting of the control interface upon a suitable voice command (e.g., “windshield wipers off”), or upon discontinuation of the vehicle function by selecting the off position with the particular vehicle control interface. Alternatively, deactivation can be time based as previously discussed. Still further, an override switch can be programmed into the system to provide the operator with the ability to disable the voice activated control interface system. For example, an operator may be completely familiar with the various individual controls in the vehicle and may interpret the vehicle control system as a nuisance or distraction. Under circumstances such as these, the voice activated control system may be deactivated by the override switch. Optionally, the voice-activated system can be activated by a pause before and/or after the voice command. In this manner, conversation within the vehicle such as between passengers, a radio, on cellular telephonic devices, and the like cannot be used to inadvertently activate lighting and/or highlighting of various functions.

By way of example, voice activated commands to the microphone such as ‘seat heater’, ‘heater’, ‘air conditioner’, and the like, can be provided to the controller to light and/or highlight the specific control interface. Depending on the commands given, the control interfaces for the seat heater controls and/or the HVAC controls can become selectively lit and/or highlighted. For example, the microphone 12 may be configured to receive voice-activated commands such as “headlights”, “heater”, “wiper”, “defroster”, “door lock”, and the like.

In another example, the media player in a vehicle can receive voice commands to light and/or highlight the particular control interface. For example, if there is voice command for the compact disc or cassette players, the control interfaces associated with control of the cassette or compact disc can be selectively lit and/or highlighted. The voice-activated command may state “radio” to light the radio control interface and then “volume” to light and/or highlight the volume control interface. In this scenario, it may be desirable to change the radio station by giving a voice command for “station” to light and/or highlight the radio control interfaces.

In another example, the microphone can receive voice activated commands to light and/or highlight the control interface for assistance and/or the control interface that provides communication with a third party such as the OnStar® communication system commercially available from the OnStar® Corporation.

Another example employs a voice activated command to rapidly identify the location of the fuel door and, if necessary, the fuel door release control, on the vehicle. The controller can be programmed to light and/or highlight an arrow on the fuel gauge control interface to show which side of vehicle the fuel door is located, and locations of the release control, in response to the voice command, such as “gas door”, “fuel”, and the like.

The voice activated control interface system advantageously provides visual signal alerts to an operator and/or passenger for the control interfaces that control actuation of the corresponding vehicle function, thereby providing a means for rapid identification. The various examples provided herein are merely exemplary and are not intended to be limiting. Other examples may include lighting and/or highlighting control interfaces for actuating the windshield wiper controls, the seat heater controls, the radio controls, the CD player controls, individual gauges, the fuel door release controls, the directional arrow for indicating the location of the fuel door, HVAC controls, interior light controls, headlight controls, defogger and defrost controls, side view mirror controls, window controls, door lock controls, cruise controls, information panel as a whole or individual gauges thereupon, hour, minute, and date set clock controls, trip mileage and the like.

Other examples suitable for use in the vehicle control system will be apparent to those skilled in the art in view of this disclosure. Advantageously, the voice activated lighting and/or highlighting of control interfaces as described above improves hand-eye coordination as well as reduces the time and level of distraction associated with making physical contact with the control interface.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A voice activated control interface system for selectively lighting and/or highlighting a control interface for a function, comprising:
a microphone for receiving a voice command;
at least one control interface in operative communication with a function; and
a controller in operative communication with the microphone and the at least one control interface, wherein the controller is adapted to process a voice command to provide a signal to a specific one of the at least one control interface to light and/or highlight the at least one control interface.

2. The system of claim 1, wherein the controller is adapted to evaluate the voice command against a lookup table to provide the signal to the specific one of the at least one control interface.

3. The system of claim 1, wherein the at least one control interface increases a light intensity, changes a light color, and/or periodically varies output of the light intensity in response to the signal.

4. The system of claim 1, wherein the control interface comprises a windshield wiper control, a defroster control, a defogger control, a heater control, an air conditioner control, a heater control for a seat, an adjustment control for seat, a rear view mirror control, a side mirror positional adjustment control, a fuel door release control, a directional indicator for a fuel door, a communication system control, a radio control, a compact disc player control, a cassette tape player control, or an ignition.

5. The system of claim 1, wherein the controller further comprises a timer function, wherein the at least one control interface is deactivated after a pre-determined amount of time.

6. A voice activated control interface system for selectively lighting and/or highlighting a control interface for a function, comprising:
a microphone for receiving at least one voice activated command;
at least one video display unit displaying at least one individual control interface in operative communication with a function; and
a controller in operative communication with the microphone and the at least one individual control interface, wherein the controller processes a voice command to provide a signal to the at least one individual control interface to light and/or highlight the at least one individual control interface.

7. The voice activated control interface system of claim 6, wherein the controller is adapted to evaluate the voice command against a lookup table to provide the signal to the specific one of the at least one individual control interface.

8. A voice activated control interface system for selectively lighting and/or highlighting an individual control interface for a function, comprising:
a microphone for receiving at least one voice activated command;
a multifunctional haptic control comprising a plurality of individual control interfaces in operative communication with selective vehicle functions; and
a controller in operative communication with the microphone and the multifunctional haptic control, wherein the controller processes a voice command to provide a signal to the multifunctional haptic control to light and/or highlight a specific one of the plurality of individual control interfaces.

9. The voice activated control interface system of claim 8, wherein the controller is adapted to evaluate the voice command against a lookup table to provide the signal to the specific one of the at least one individual control interface.

10. A method for selectively lighting and/or highlighting a control interface for a particular function, the method comprising:
processing a voice command with a controller to provide a signal to a specific control interface; and
lighting and/or highlighting the specific control interface in response to the signal.

11. The method of claim 10, further comprising deactivating the lighting and/or highlighting of the control interface, wherein deactivating comprises manually switching off the lighting and/or highlighting the control interface.

12. The method of claim 10, further comprising deactivating the lighting and/or highlighting of the control interface wherein deactivating comprises programming the controller to discontinue the signal after a predetermined period of time.

13. The method of claim 10, wherein processing the voice command comprises evaluating the voice command against a look up table and providing the signal to the specific control interface.

14. The method of claim 10, wherein lighting and/or highlighting the specific control interface comprises increasing a light intensity, changing a light color, varying a light intensity output, and combinations comprising at least one of the foregoing.

15. The method of claim 10, wherein the control interface comprises a windshield wiper control, a defroster control, a defogger control, a heater control, an air conditioner control, a heater control for a seat, an adjustment control for the seat, a rear view mirror control, a side mirror control, a fuel door release control, a fuel door location control, a cruise control, a traction stability control, a computer control, an interlock control, a communication system control, and a media player control.
